(19) United States
(12) Patent Application Publication
(10) Pub. No.: US 2025/0205781 A1
(43) Pub. Date: Jun. 26, 2025

(54) ASSEMBLY AND METHOD FOR PRODUCING METAL POWDER

(71) Applicant: SPACE-XYZ IP B.V., Terborg (NL)

(72) Inventors: Franciscus Quirinus Fredrik VEROUDEN, Terborg (NL); Mathijs Cornelis Theodorus REULING, Terborg (NL)

(21) Appl. No.: 19/075,524

(22) Filed: Mar. 10, 2025

Related U.S. Application Data
(63) Continuation of application No. 17/271,254, filed on Feb. 25, 2021, now abandoned.

(30) Foreign Application Priority Data
Aug. 28, 2018 (NL) 2021507

(51) Int. Cl. B22F 9/08; B22D 43/00

(52) U.S. Cl. CPC B22F 9/082; B22D 43/004; B22F 2009/0844; B22F 2009/0888; B22F 2009/0896

(57) ABSTRACT

An assembly and method for producing powder are provided. The assembly includes a melting chamber, an atomizing vessel, and a powder processing device. The melting chamber includes a crucible, a tundish, and a filtering device. The crucible is arranged for melting a material. The crucible and tundish are configured for providing a flow path for the melted material from the crucible into the tundish. The filtering device is arranged in the flow path. The tundish is connected to an atomizing nozzle. The atomizing nozzle is configured to direct molten material from the tundish towards and into the atomizing vessel. The atomizing vessel comprises an outlet which is configured to extract solidified, atomized particles of the formerly molten material from the atomizing vessel. The powder processing device includes one or more separation units which are arranged for outputting one or more powders from the atomized particles.

### CROSS-REFERENCE TO RELATED APPLICATIONS

This application is a continuation of U.S. patent application Ser. No. 17/271,254 filed on Feb. 25, 2021, and entitled “ASSEMBLY AND METHOD FOR PRODUCING METAL POWDER,” which application is expressly incorporated herein by reference in its entirety.

The invention relates to an apparatus and method for producing metal powder, in particular metal powder having particles with sizes below 200 micrometers.

### BACKGROUND

It is known that metal powder can be produced by atomizing molting metal with a blast of gas, freezing the atomized metal into finely divided solid particles, and recovering the resulting metal powder.

The United States Patent application US 2008/0271568 A1 describes an apparatus for the gas atomization of molten material. The apparatus comprises a tundish adapted to contain molten metal to be atomized. The tundish is arranged at an upper inlet end of an atomizing vessel. Below the tundish, an atomizing nozzle is arranged, which atomizing nozzle is connected to the outlet of the tundish in order to supply the molten metal from the tundish to the atomizing nozzle. In use, molten metal issuing from the atomizing nozzle is being impinged upon by an atomizing gas in an atomizing zone in the atomizing vessel, below the atomizing nozzle. The subsequently solidified, atomized particles obtained from the formerly molten material, are suspended in the atomizing gas, which delivers the atomized particles to a cyclone. The cyclone separates the atomized particles form the atomizing gas. The atomized particles are transferred to a receiving vessel at the bottom of the cyclone, and the atomizing gas from the cyclone is cooled from its extraction temperature and then at least a proportion of this cooled gas is re-circulated and re-introduced into the atomizing vessel.

A similar arrangement is also described in U.S. Pat. No. 5,935,461.

One of the applications for the atomized particles is their use in a three-dimensional printing apparatus in which the atomized particles are locally fused together, preferably layer by layer, to form the desired piece of equipment. Since the atomized particles form the building blocks for use in such a three-dimensional printing process, the properties and/or quality of the element manufactured strongly depends on the powder of atomized particles used in the three-dimensional printing apparatus.

### SUMMARY OF THE INVENTION

There are many problems with the known apparatuses for gas atomization of molten material. For example, it is very difficult to obtain atomized particles of the desired shapes and sizes and/or to obtain the desired size distribution of the atomized particles. Also, the powder of atomized particles is preferably made from very pure material and with substantially no contaminations, which inter allia means that highly pure starting material is used for melting in the tundish, that no recycled material is used, and that the apparatus must be thoroughly cleaned when changing the production of atomized particles from one material to another different material.

It is an object of the present invention to least partially solve at least one of the above identified disadvantage and/or to provide an alternative assembly for producing metal powder using gas atomization of molting, in particular for use in a three-dimensionally printing apparatus.

According to a first aspect, an embodiment of the present invention provides an assembly for producing metal powder, wherein said assembly comprises:
a melting chamber comprising a transfer device, a melting device and a tundish, wherein the melting device comprises a crucible for melting metal material and holding said melted metal material, wherein the transfer device is configured to position metal material into the crucible at elevated temperature, wherein the crucible is configured for providing a flow path for allowing a flow of said melted metal material from the crucible into the tundish, wherein the tundish is connected to an atomizing nozzle, wherein the melting chamber further comprises a filtering device with a filtering element which is arranged between the crucible and the tundish, wherein the filtering element is arranged in said flow path,
an atomizing vessel comprising an inlet end, wherein the atomizing nozzle is configured to direct molten metal material from the tundish towards and into the inlet end of the atomizing vessel, wherein the atomizing vessel comprises an outlet opening which is configured to extract solidified, atomized particles of the formerly molten metal material from the atomizing vessel, and
a powder processing device connected to the outlet opening of the atomizing vessel, wherein said powder processing device comprising multiple separation units, wherein each separation unit of said multiple separation units is configured for extracting a different fraction out of the solidified atomized particles from the atomizing vessel, wherein the different fractions comprise different weight fractions and/or different size fractions, and for providing multiple different fractions as separate products of the assembly for producing powder.

The powder production in the assembly of the present invention produces powder with a certain distribution of particles with different weights and sizes, which usually not an optimal distribution for use in a three-dimensional printing apparatus. Accordingly, the assembly of the present invention provides a complete solution for not only producing metal powder, but also for separating the produced powder in multiple different separate fractions. From these multiple fractions the desired distribution for use in a three-dimensional printing apparatus can be selected or can be assembled by combining powders from two or more of said multiple different fractions. Accordingly, the produced powder fractions are readily available for use in a three-dimensional printing apparatus. No costly and/or time consuming after treatment is required obtain atomized particles of the desired shapes and sizes and/or to obtain the desired size distribution of the atomized particles in a powder for three-dimensional printing apparatus.

The invention provides an assembly for producing metal powder and for separating the produced metal powder with powder particles with the certain weight distribution and/or size distribution in several different separate fractions. Accordingly, a selection from one or more of these several different fractions can be used for providing a powder with weight and/or size distribution equal or close to a desired distribution.

Furthermore, since the transfer device is configured to position metal material into the crucible at elevated temperature, new to be melted metal material can be positioned into the crucible without the need of cooling down the assembly and in particular the crucible. Positioning to be melted metal material in a crucible at the melting temperature of said metal is usually not done, because the crucible is highly fragile at such high temperatures. However, this is exactly what the transfer device according to the present invention is designed to do, in order to enable a quasi-continuous process of subsequently melting small volumes of metal for providing each of said small volumes of melted metal subsequently to the tundish for atomizing said melted metal.

In addition, the assembly is configured for repetitively handling a relatively small volume of liquid metal. Accordingly, the amount of liquid metal at any one moment in the assembly of the present invention is relatively small, which reduces the hazards associated with handling large amounts of liquid metal.

In an embodiment, the crucible is configured for holding melted metal material with a volume in a range of approximately 10—0.1 liters, preferably with a volume in a range of approximately 5—0.5 liters, more preferably with a volume in a range of approximately 3—1 liters. Accordingly, the assembly is of such a scale that it can easily be arranged in the same factory, preferably close to the three-dimensional printing apparatus. Preferably the assembly is of such a scale that it can be arranged in a container, preferably a shipping container, preferably of standard size.

In an embodiment, the assembly comprises a fluid conduit, wherein the fluid conduit debouches near and/or in the tundish, in particular near an upper side of the tundish, in particular for providing a substantially inert gas into the tundish. The fluid conduit is configured to provide an inert gas into the tundish, in particular in order to fill the inside of the tundish with said inert gas. Accordingly, the melted material inside the tundish can be covered with a layer of inert gas, which inert gas is selected or configured in order to at least substantially prevent contamination of the melted material inside the tundish and/or to at least substantially prevent chemical reactions of the melted material with ambient gasses, such as oxidation of the melted material by oxygen.

An alternative way to prevent contamination or chemical reactions of the melted material, is to use a vacuum chamber as the melting chamber. By removing ambient gasses out of the melting chamber, the contamination or chemical reactions with ambient gasses can be prevented. However this solution requires the use of a vacuum chamber, vacuum pumps, etc. . . . , which makes the assembly expensive, bulky and elaborate to work with. By using a fluid conduit to provide an inert gas at least to the tundish as presented in the embodiment described above, a vacuum chamber, vacuum pump, etc. . . . are not necessary

In an embodiment, the transfer device is configured to position a materials container, comprising to be melted material, into the crucible. Accordingly, the to be melted material is delivered to the crucible in a materials container with well-defined dimensions, which are independent of the shape and form of the to be melted material inside the materials container. This allows easy and precise handling of the to be melted material, in particular to place the to be melted material into the crucible, substantially independent of the shape and form of the to be melted material inside the container. This allows to place discarded products from the three-dimensional printing process, or parts thereof inside the container, to be re-used for producing powder, in particular for use in a three-dimensionally printing apparatus.

Usually the to be melted material is placed in a cold crucible, which crucible is subsequently heated to allow the material inside to melt. When the melted material has flown out of the crucible, the crucible is cooled down before new material is again placed in the could crucible. As already stated above, a hot crucible is very fragile. By delivering the to be melted material in a materials container with well-defined dimensions, which are preferably optimized to the dimensions of the inner space in the crucible, the materials container can be placed in a hot crucible. The transfer device is configured to position the materials container with the well-defined dimensions accurately and carefully inside the crucible, substantially without the side walls of the materials container abutting the side walls of the crucible. Accordingly the materials container can be positioned inside a hot crucible substantially with a minimal risk of damaging the crucible.

In an embodiment, the materials container is made from the same, to be melted material. The materials container melts together with the melted material and the material of the container is also used for the producing powder. Accordingly, the container does not need to be removed from the crucible.

In an embodiment, the materials container is made from a combustible material. During the melting of the material inside the materials container, the materials container is combusted. Accordingly, the container does not need to be removed from the crucible. Any residue from the combusted materials container can be removed from the liquid material by the filtering device, in particular when the liquid material is transferred from the crucible to the tundish. Examples of such a combustible materials are cardboard, plastic or polymer materials.

In an embodiment, the outer diameter of the materials container is smaller than the inner diameter of the crucible. Preferably the outer diameter of the materials container is 1 to 10 mm smaller than the inner diameter of the crucible. Although the difference in diameter may be even smaller than 1 mm, such smaller diameter differences require a highly accurate, precise and expensive transfer device. Also the difference in diameter may be larger than 10 mm, however in that case a large amount of space in the crucible is not used.

In an embodiment, the melting chamber comprises a storage device and/or a storage space which is arranged for accommodating multiple materials containers inside the melting chamber. The storage device is configured for subsequently presenting one of said multiple materials containers to the transfer device, and/or the transfer device is arranged for taking one of said multiple materials containers out of the storage device and/or storage space. Accordingly, the storage device and/or storage space allows to place multiple materials containers inside the melting chamber and to refill the crucible inside the melting chamber without the need to open the melting chamber and disturb the production process, at least as long as there are materials containers in the storage device and/or storage space.

In an embodiment, the storage device comprises a storage turret with multiple material container storage positions, which materials container storage positions are preferably distributed at the circumference of said storage turret. The storage turret allows to provide multiple materials containers with to be melted material inside the melting chamber. The storage turret is preferably provided with a rotating device, which rotating device is configured to be actuated from outside the melting chamber, and which is configured to subsequently present individual materials containers to the transfer device. Preferably, the storage turret is provided with an transfer position which is configured to present a stored materials container and to allow the transfer device to transfer the stored materials container from the storage turret into the crucible. After a stored materials container had been removed from the storage turret, the storage turret van be rotated to move a further stored materials container to the transfer position. In an embodiment, the transfer position of the storage turret is arranged facing the crucible.

In an embodiment, the powder processing device comprises one or more sifting units, wherein each sifting unit of said one or more sifting units is arranged for extracting a predetermined size fraction of atomized particles. An advantage of using sifting units is, that they provide a sharp upper limit for particles that can pass the sifting unit, which upper limit is determined by the mesh size of the sieve or screen in the sifting units; particles with a size larger than the mesh size will not pass the sieve or screen and are efficiently separated from particles with a size smaller than the mesh size.

In an embodiment, the powder processing device comprises one or more cyclone separation units, wherein each cyclone separation unit of said one or more cyclone separation units is arranged for extracting a predetermined weight fraction of atomized particles. Because cyclone separation units usually do not comprise a sieve or screen, which in time may become at least partially blocked by particles getting stuck in the mesh, the performance of cyclone separation units is usually more constant over time and require less maintenance.

In an embodiment, the powder processing device comprises one or more air classifiers, wherein each air classifier of said one or more air classifiers is arranged for extracting a predetermined fraction of atomized particles base on a combination of size, shape and density. Such an air classifier is in particular suitable for extracting a fraction from small and light powders.

It is noted that the powder processing device may also comprise a combination of a sifting unit, a cyclone separation unit and/or an air classifier.

In an embodiment, the powder processing device comprises a combining unit which is configured to combine amounts of powder from several of said different fractions in order to provide a powder mixture with a preselected size and/or weight distribution. The size and/or weight distribution of the powder used in a three-dimensional printing process influences the printing process and/or the properties of the printed product. For example, when the size distribution is selected to minimize the space between the powder particles, any shrinking of the powder bed during the melting and/or fusing the particles can be reduced. In alternative example, the size distribution is selected to provide a substantial space between the powder particles, which results after fusing the powder particle together, preferably without completely melting the powder particles, in a material with is at least partially porous. Accordingly, the combining unit can provide a powder mixture with powder particles of a desired distribution, preferably optimized for a certain application and/or for obtaining certain material properties of the printed material.

In an embodiment, the assembly comprises two or more powder processing devices, each powder processing device is configured for processing atomized particles of one particular material, and wherein each one of the two or more powder processing device are configured for processing atomized particles of a different material. The inventors have found that it can be notorious difficult to completely cleaning the powder processing device. When some residues from a first material remains in the powder processing device, and the same powder processing device is used for processing a second material, the second material can be contaminated by the residues of the first material. In order to circumvent such contamination, the assembly is provided with two or more powder processing devices for processing atomized particles of different materials. Different materials can be processed separately and contamination by different materials can be prevented.

In an embodiment, the filtering element is configured to filter out contaminations and/or particles, preferably contaminations and/or particles with a diameter substantially equal to or larger than a diameter of the atomizing nozzle.

Said contaminations may comprise oxides, which need to be removed from the melted metal. Usually said oxides have a higher viscosity than the pure melted metal and are collected by and removed from the melted metal by the filtering element.

Accordingly, the filtering element on the one hand is used to purify the melted metal. On the other hand the filtering element can at least prevent a blocking of the atomizing nozzle by contaminations and/or particles.

The filtering element of the filtering device is arranged for removing contaminants from the liquid material before it flows into the tundish. For example, when the assembly is used for making metal powder, the filtering element is configured for removing any slag from the melted metal before the melted metal flows into the tundish.

In an embodiment, the filtering device is coupled to the crucible. In an embodiment, the filtering element is arranged adjacent to an outflow channel of said crucible. The coupling of the filtering device to the crucible is configured and intended to ensure that the liquid material traverses the filtering element when the liquid material flows out of the outflow channel. For example, when using a tilting crucible, the upper rim of the crucible usually comprises a pouring sprout which is the outflow channel for liquid metal from said tilting crucible. Accordingly, the filtering device is coupled to said crucible adjacent to the pouring sprout.

In an alternative embodiment, the filtering device is coupled to the tundish. In an embodiment, the filtering element is arranged in front of an input opening of said tundish. The coupling of the filtering device to the tundish is configured and intended to ensure that the liquid material traverses the filtering element, before the liquid material flows into the tundish. It is noted that the filtering device does not necessary need to cover the whole input opening of the tundish. The filtering element is arranged in front of at least the part of the input opening where the liquid material from the crucible flows into the tundish.

In another alternative embodiment, the filtering device is arranged spaced apart from the crucible and the tundish, wherein the filtering element is arranged in the flow path of the liquid material from the crucible and into the tundish. Again, the position of the filtering device in the melting chamber is configured and intended to ensure that the liquid material traverses the filtering element, when the liquid material flows from the crucible and before the liquid material flows into the tundish.

In an embodiment, the filtering device comprises an overflow arrangement, wherein the overflow arrangement is configured for directing at least a part of the liquid material which does not flow through the filtering element, to flow into a waste container. The overflow arrangement ensures that the liquid material is suitably removed or removable from the melting chamber in case the filter element blocks at least part of the flow of the liquid material from the crucible into the tundish.

In an embodiment, the filtering device comprises a filter turret comprising multiple filtering elements, wherein the filter turret is rotatable for moving one of the multiple filtering elements into and out of the flow path of the liquid material. In an embodiment, the multiple filtering elements are individually arranged in a filter element holder. The filter turret allows to easily exchange the filtering element in the flow path of the liquid material by another one of said multiple filtering elements, in particular by rotating said filter turret. The filter turret is preferably provided with a rotating device, which rotating device is configured to be actuated from outside the melting chamber.

According to a second aspect, an embodiment of the invention provides a method for producing powder, wherein the method comprises the steps of:
positioning an amount of material in a hot crucible,
melting the amount of material in the crucible,
transferring the liquid material from the crucible to a tundish, wherein the liquid material from the crucible traverses a filtering element before the liquid material flows into the tundish,
directing molten material from the tundish, via an atomizing nozzle towards and into an inlet end of an atomizing vessel in order to produce atomized particles which solidify in the atomizing vessel,
extracting the solidified, atomized particles of the formerly molten material via an outlet opening of the atomizing vessel and directing said solidified atomized particles to a powder processing device,
using multiple separation units of the powder processing device such that each separation unit of said multiple separation units extracts a different fraction out of the solidified atomized particles from the atomizing vessel, wherein the different fractions comprise different weight fractions and/or different size fractions, and providing multiple different fractions as separate products of the assembly for producing powder.

In an embodiment, the above steps of the method are subsequently carried out and/or are carried out recurrently, preferably without substantially cooling down the crucible.

In an embodiment, the method is carried out using an assembly as described above or an embodiment thereof.

In an embodiment, the method comprises the step of providing an inert gas at least in the tundish before transferring the liquid material from the crucible to the tundish. On the one hand the tundish is flushed with inert gas to remove any residual contamination in the tundish before it receives the molten material. On the other hand, the inert gas in the tundish provides an inert shielding of the molten material during and/or after it has traversed the filtering element. Due to this shielding effect, the crucible and the tundish do not need to be arranged in a vacuum chamber.

According to a third aspect, an embodiment of the invention provides a materials container for use in an assembly for producing powder, wherein said assembly comprises a melting chamber comprising a melting device, wherein the melting device comprises an receptacle, wherein the receptacle is configured for positioning the materials container into the melting device, wherein the materials container comprises to be melted material. Accordingly, the to be melted material is delivered to the melting device in a materials container with well-defined dimensions, which are independent of the shape and form of the to be melted material inside the materials container. This allows easy and precise handling of the to be melted material, in particular to place the to be melted material into the receptacle of the melting device, substantially independent of the shape and form of the to be melted material inside the materials container. This allows to place discarded products from the three-dimensional printing process, or parts thereof inside the materials container, to be re-used for producing powder, in particular for use in a three-dimensionally printing apparatus.

Usually the to be melted material is placed in a cold melting device, such as a crucible, which melting device is subsequently heated to allow the material inside to melt. When the melted material has flown out of the melting device, the melting device is cooled down before new material is again placed in the cooled down melting device. It turns out that a hot melting device, in particular when the melting device comprises a crucible or tundish, is very fragile. The repeatedly subsequent heating and cooling of the melting device may induce mechanical tensions in the material of the melting device, which mechanical tensions may lead to shattering of the melting device.

By delivering the to be melted material in a materials container with well-defined outer dimensions, the materials container can be placed in a hot melting device. The transfer device is configured to position the materials container with the well-defined dimensions accurately and gently inside receptacle of the melting device, preferably without the side walls of the materials container abutting the side walls of the receptacle. Accordingly the materials container can be positioned inside a hot melting device substantially with a minimal risk of damaging the melting device.

In an embodiment, the materials container is made from a combustible material. In an embodiment, the materials container is made from the same, to be melted material.

According to a fourth aspect, an embodiment of the invention provides an assembly for producing powder, wherein said assembly comprises a melting chamber comprising a melting device, wherein the melting device comprises an receptacle and a heating device, wherein the receptacle is configured for receiving a materials container, wherein the heating device is configured for heating the materials container in the receptacle. Preferably, the heating device is also configured for melting the materials container and the to be melted material inside the material container.

Preferably, the outer diameter of the materials container is smaller than the inner diameter of receptacle of the melting device. Preferably the outer diameter of the materials container is 1 to 10 mm smaller than the inner diameter of the receptacle of the melting device. Although the difference in diameter may be even smaller than 1 mm, such smaller diameter differences require a highly accurate, precise and expensive transfer device. Also the difference in diameter may be larger than 10 mm, however in that case a large amount of space in the melting device is unused.

In an embodiment, the melting chamber comprises a transfer device, wherein the transfer device is configured for positioning the materials container inside the receptacle of the melting device.

In an embodiment, the melting chamber comprises a storage device which is arranged for accommodating multiple materials containers inside the melting chamber,
wherein the storage device is configured for subsequently presenting one materials container of said multiple materials containers to the transfer device, and/or
wherein the transfer device is configured for taking one materials container of said multiple materials containers out of the storage device.

In an embodiment, the storage device comprises a storage turret with multiple materials container storage positions, which materials container storage positions are preferably distributed at the circumference of said storage turret. Preferably each one of the multiple materials container storage positions is configured for holding at least one materials container.

In an embodiment, the melting device comprises a tundish, wherein the tundish comprises an outlet, wherein the assembly further comprises:

An atomizing nozzle in fluid connection with the outlet of the tundish,
an atomizing vessel comprising an inlet end, wherein the atomizing nozzle of the tundish is configured to direct molten material towards and into the inlet end of the atomizing vessel, wherein the atomizing vessel comprises an outlet opening which is configured to extract solidified, atomized particles of the formerly molten material from the atomizing vessel, and
a powder processing device comprising one or more separation units which are arranged for outputting one or more powders from said atomized particles.

In an alternative embodiment, the melting device comprises a crucible, wherein the melting chamber further comprises a tundish, wherein the crucible is configured for providing a flow path for allowing a flow of melted material from the crucible into the tundish, wherein the tundish comprises an outlet, wherein the assembly further comprises:
an atomizing nozzle in fluid connection with the outlet of the tundish,
an atomizing vessel comprising an inlet end, wherein the atomizing nozzle of the tundish is configured to direct molten material towards and into the inlet end of the atomizing vessel, wherein the atomizing vessel comprises an outlet opening which is configured to extract solidified, atomized particles of the formerly molten material from the atomizing vessel, and
a powder processing device comprising one or more separation units which are arranged for outputting one or more powders from said atomized particles.

In an embodiment, the melting chamber further comprises a filtering device which is arranged between the crucible and the tundish, wherein the filtering device is arranged in said flow path.

In an embodiment, the assembly comprises a plug member, wherein the plug member is movable from positioning a tip end of said plug member in the atomizing nozzle. The plug member allows to substantially close off the atomizing nozzle, in order to control the starting or stopping of the atomizing process. In addition, the tip end can be used for pushing any residual material out of the atomizing nozzle, for example to clean the atomizing nozzle, in particular after substantially all material has been flowing out of the tundish. In an embodiment, the plug member comprises a stopper rod.

In an embodiment, the plug member comprises an internal conduit which is part of the fluid conduit of the assembly, wherein the internal conduit debouches in a circumferential surface of the plug member, in particular near an upper side of the tundish when the tip end is arranged inside the atomizing nozzle.

In an embodiment, the melting device comprises a heating element, wherein the heating element comprises an inductive heating. Inductive heating provides a clean and non-contact process for heating up an electrically conducting material, such as metals. In particular when the assembly is used for producing metal powders, such an inductive heating can directly heat up the to be melted metal material in the melting device.

In an embodiment, the melting device comprises a heating element, wherein the heating element comprises a resistance heating. A resistance heating allows to heat up the melting device and the to be melted material inside the melting device even if no electrically conducting material is present. In particular when the assembly is used for producing metal powders, the resistance heating allows heating the melting device, in particular a crucible, even when no to be melted metal material is arranged inside the melting device.

It is noted that in an embodiment, the melting device may also comprise both an inductive heating and a resistance heating.

According to a fifth aspect, an embodiment of the invention provides a method of heating a materials container, preferably a materials container according to the third aspect as described above, in an assembly according to the fourth aspect as described above. The method comprises the step of positioning the materials container inside the receptacle of the melting device, wherein the receptacle of the melting device is preheated by the heating device, wherein the materials container is heated in the receptacle by the heating device.

According to a sixth aspect, an embodiment of the invention provides an atomizing nozzle for use in an assembly for producing powder, wherein the atomizing nozzle comprises an inlet opening and an outlet opening which are connected via a flow passage, wherein the atomizing nozzle at or around the inlet opening comprises a supporting and/or closing member for a tundish with an outlet opening for melted material, in particular for arranging the outlet opening of said tundish adjacent or adjoining the inlet opening of said atomizing nozzle. Although the atomizing nozzle and the tundish can be configured as a single combined component, it is preferred that the atomizing nozzle and the tundish are separate components. Preferably the atomizing nozzle is configured so that the tundish abuts the atomizing nozzle and its position with respect to the atomizing nozzle is maintained by gravity. Accordingly the tundish can easily be separated from the atomizing nozzle by lifting the tundish, which makes it easy to exchange the atomizing nozzle and/or the tundish for a new one.

Preferably the closing member is configured to provide a closely fitting contact between the tundish and the atomizing nozzle. Preferably the closing member is configured to minimize an opening between the contact surfaces of the tundish and the atomizing nozzle, and/or in order to provide a long leakage path between the contact surfaces of the tundish and the atomizing nozzle, in order to minimize any leakage between the tundish and the atomizing nozzle.

In an embodiment, the atomizing nozzle comprises a heating member for heating melted material in said atomizing nozzle and/or for heating the atomizing nozzle. In an embodiment, the heating member comprises one or more of a gas burner, an inductive heating, and a resistive heating. By providing a heating member for heating the material in said atomizing nozzle and/or the atomizing nozzle itself, it can be prevented that the material in said atomizing nozzle cools down and, in the event that the material at least partially solidifies, blocks the atomizing nozzle.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of exemplary embodiments shown in the attached drawings, in which:

FIG. 1 shows a schematic presentation of an embodiment of a first example of an assembly for producing powder;

FIG. 2 schematically shows a second example of a part of an embodiment of an assembly for producing powder;

FIGS. 3A and 3B schematically show different views of a third example of a part of an embodiment of an assembly for producing powder;

FIG. 4 schematically shows a fourth example of a part of an embodiment of an assembly for producing powder;

FIGS. 5A and 5B schematically shows a fifth example of a part of an embodiment of an assembly for producing powder;

FIG. 6 schematically shows an example of an embodiment of a tundish for use in an assembly for producing powder;

FIGS. 7A, 7B and 7C schematically show different example of embodiments of assemblies with different powder processing devices;

FIG. 8 schematically shows an example of a size distribution of powder particles as obtained by an assembly of the present invention, and a size distribution of powder particles as created using powder from different fractions of the original distribution;

FIG. 9 schematically shows a further example of an embodiment of an assembly with interchangeable powder processing devices; and

FIG. 10 shows a schematic presentation of an embodiment of a further example of an assembly for producing powder;

### DETAILED DESCRIPTION OF THE INVENTION

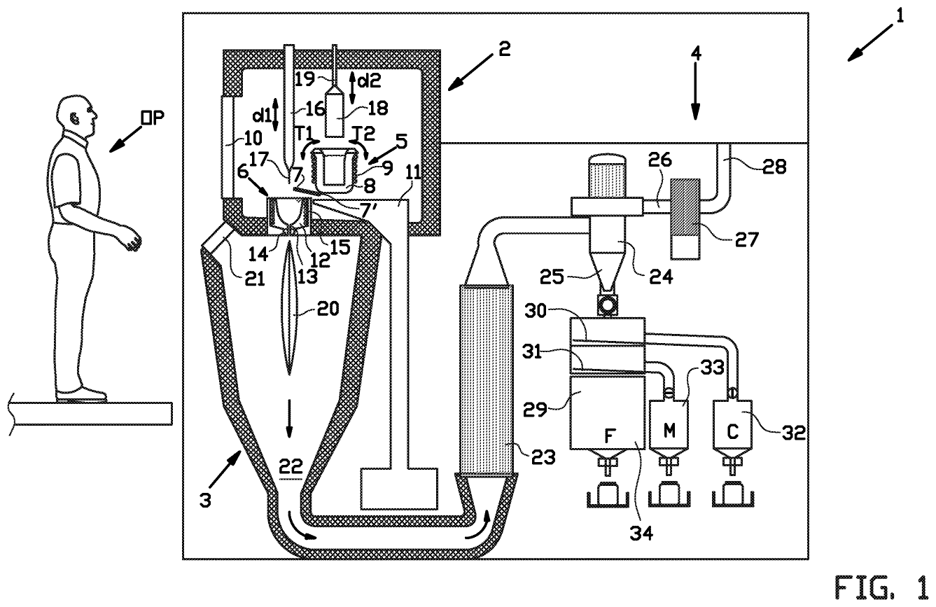

FIG. 1 schematically shows an example of an assembly 1 according to the present invention. The assembly comprises a melting chamber 2, an atomizing vessel 3, and a powder processing device 4.

The melting chamber 2 comprises, inter alia, a crucible 5, a tundish 6 and a filtering device 7. The crucible 5 is arranged for melting a material. In particular the crucible 5 is arranged for melting metal material for producing metal powder. The crucible 5 comprises a container 8 which is made from a ceramic material and is provided with a coil 9 for inductively heating and melting metal material inside said crucible 5. At least in use the coil 9 is connected to a power source for directing a suitable current through the coil 9 for inductively heating the metal inside the container 8. As schematically shown in the example of FIG. 1, the coil 9 comprises a hollow tube which allows to provide a cooling fluid to flow through the tube for cooling the coil 9 during use.

The crucible 5 and tundish 6 are configured for providing a flow path for said melted material from the crucible 5 into the tundish 6. For example the crucible 5 is configured for tipping in the direction T1 of the tundish 6 and for pouring melted material from the crucible 5 into the tundish 6.

As schematically indicated in FIG. 1, the filtering device 7 is arranged in said flow path between the crucible 5 and the tundish 6. The filtering device 7 is arranged for filtering out irregularities from the melted material. In case the melted material is a metal, the melt may comprise irregularities, such as slag, which are filtered out of the melted material before it flows into the tundish 6.

It is noted, that in case melted material cannot pass the filtering device 7, the melting chamber 2 is provided with a flow path which directs the overflowing melted material from the filtering device 7 towards a disposal system 11. For example, the filtering device 7 may be arranged in a filter holder 7′ which substantially extends above the edge of the tundish 6 towards the disposal system 11. Accordingly, any overflowing melted material can flown over the filter holder 7′ into the disposal system 11.

It is further noted, that the crucible 5 is configured for tipping in the direction T2 towards the disposal system 11 in order to empty the crucible 5 by pouring the melted material from the crucible 5 directly into the disposal system 11. In case the melted material comprises to much irregularities or when an operator OP is of the opinion that the melted material is not suitable for producing powder, the melted material in the crucible 5 can be disposed of by pouring the melted material into the disposal system 11. The melting chamber 2 is preferably provided with observation means which allow the operator OP to view and check the melted material in the crucible 5. This observation means may comprise a camera mounted in the melting chamber 2 or, in a simple embodiment, may comprise a window 10 in a side wall of the melting chamber 2.

The tundish 6 comprises a container 12 with an opening 13 in the bottom wall, which opening 13 connects to an atomizing nozzle 14. The tundish 6 also comprises a coil 15 for resistively heating the tundish 6 and/or for inductively heating a metal inside the container 12. Also this coil 15 comprises a hollow tube which allows to provide a cooling fluid to flow through the hollow tube for cooling the coil 15 during use, in particular in case the coil 15 is used for inductively heating a metal inside the container 12. The opening 13 and the atomizing nozzle 14 usually have a small diameter and may be at least partially blocked when the melted material in the tundish 6 would comprise particles. By using the filtering device 7 for filtering the melted material before it is poured into the tundish 6, blocking of the opening 13 and/or the atomizing nozzle 14 by particles in the melted material can at least substantially be prevented.

As schematically shown in FIG. 1, the melting chamber 2 also comprises a plug member 16 with a thin tip 17, which tip 17 is configured to be inserted into the opening 13. Preferably the tip 17 extends also into the atomizing nozzle 14. The plug member 16 is moveable in a direction towards and away from the tundish 6, in this example substantially in a vertical direction d1. The plug member allows to substantially closing off the opening 13, in order to control the starting or stopping of the atomizing process. In addition, the tip 17 can be used for pushing any residual material out of the opening 13 and preferably out of the atomizing nozzle 14 when substantially all material has been flowing out of the tundish 6.

Furthermore, the melting chamber 2 comprises a materials container 18 comprising to be melted material. The materials container 18 is connected to a manipulator device 19 which allows positioning the materials container 18 into the crucible 5, and release the materials container 18. In the schematic simplified presentation in FIG. 1, the manipulator 19 is configured to move the materials container 18 at least in a substantially vertical direction d2 to move the materials container 18 into the crucible 5. In particular, the materials container 18 is made from the same to be melted material as is arranged inside the materials container 18. Accordingly, both the materials container 18 and the material inside the materials container 18 are melted when arranged inside the crucible 5. Alternatively, the materials container 18 is made from a combustible material During the melting of the material inside the materials container 18, the materials container is combusted 18.

Alternatively, the manipulator 19 may comprises a robot arm (not shown) which allows for a more complex movement and handling of the materials containers 18, for example for moving a materials container 18 from a supply of materials containers 18 inside the melting chamber 2 into the crucible 5. After the crucible 5 has melted at least the material inside the materials container 18, and the melted material is poured out of the crucible 5, the manipulator 19 then can take a further materials container 18 from the supply of materials containers 18 and position this further materials container 18 into the crucible 5. Accordingly, as long as there are material containers in the supply of materials containers, the melting and atomizing process can continue without a need for opening the melting chamber 2.

As schematically shown in FIG. 1, the atomizing nozzle 14 of the tundish 6 debouches in an upper side of the atomizing vessel 3. The atomizing nozzle 14 is configured to direct molten material towards and into the atomizing vessel 3. In particular, the atomizing nozzle 14 is configured to direct one or more jets of a fluid, preferably a gas, towards the flow of molten material in order to split the flow of molten material into small droplets. The cloud of droplets 20 is pushed away from the atomizing nozzle 14 and the droplets 20 in the cloud of droplets 20 cool down and solidify as they travel through the atomizing vessel 3. As schematically shown in FIG. 1, the atomizing vessel 3 is provided with a window 21 to allow an operator OP to monitor and/or inspect the cloud of droplets 20.

The atomizing vessel 3 further comprises an outlet 22 which is configured to extract solidified, atomized particles of the formerly molten material from the atomizing vessel 3. In the example shown in FIG. 1, the outlet 22 is arranged at a side of the atomizing vessel 3 which is opposite to side where the atomizing nozzle 14 debouches into the atomizing vessel 3. The fluid used in the atomizing process also leaves the atomizing vessel 3 via the outlet 22 and takes the solidified, atomized particles along with it towards a cooling member 23. In an example as shown in FIG. 1, the cooling member 23 is a heat exchanger which is configured for cooling down the solidified, atomized particles and/or the fluid carrying said solidified, atomized particles.

The fluid with solidified, atomized particles is subsequently directed to the powder processing device 4 which comprises one or more separation units which are arranged for outputting one or more powders from said atomized particles. In the example shown in FIG. 1, the fluid with solidified, atomized particles is directed towards a cyclone separator device 24. The cyclone separator device 24 generally separates the heavier atomized particles from the fluid. The heavier atomized particles are collected and outputted at the bottom part 25 of the cyclone separator device 24. The fluid is outputted at the top output 26. It is noted that the fluid outputted at the top output 26 may still contain some light weight atomized particles.

The fluid outputted at the top output 26 of the cyclone separator device 24 is directed through a filter device 27 and is expelled out of a fluid output 28 of the assembly 1. It is noted that in a further development, the fluid outputted at the fluid output 28 may be recycled and/or re-used for the above described atomizing process.

The atomized particles collected and outputted at the bottom part 25 of the cyclone separator device 24, are directed to a sifting assembly 29. In the example shown in FIG. 1, the sifting assembly 29 comprises a first sieve 30 and a second sieve 31, wherein the mesh openings in the second sieve 31 are smaller than the mesh openings in the first sieve 30. The first sieve 30 filters out the atomized particles with a size too large to pass through the first sieve 30. These relatively large particles are outputted from the sieve assembly 29 into a first storage container 32 for the coarse powder material C. The second sieve 31 filters out the atomized particles which pass through the first sieve 30, but which have a size too large to pass through the second sieve 31. The relatively medium sized particles are outputted from the sieve assembly 29 into a second storage container 33 for the medium sized powder material M. The atomized particles which pass through both the first sieve 30 and the second sieve 31 are collected at the bottom of the sieve assembly 29 which provides a third storage container 34 for fine powder material F.

It is noted that in case one or more of the collected fractions of powder material is not desired or not needed for short term use, these fractions of powder material may be recycled by putting these fractions of powder material inside a materials container 18 for future use in the assembly 1 for the production of powder material.

It is noted that in the example as depicted in FIG. 1, the filtering device 7 is arranged between the crucible 5 and the tundish 6.

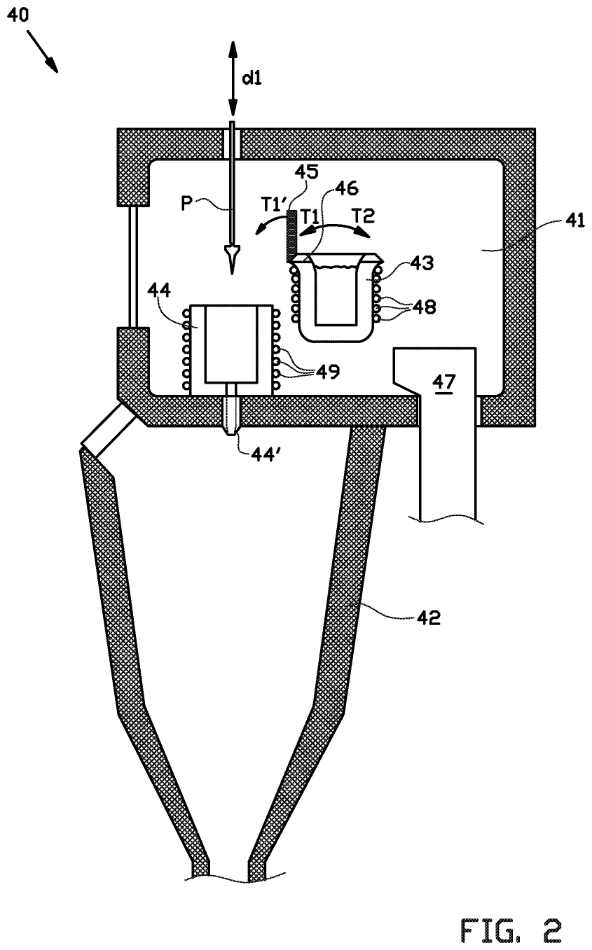

FIG. 2 shows a second example of a part of an assembly 40 for producing powder. It is noted that in FIG. 2 only some major components of the assembly 40 are shown to illustrate the difference between this second example and the first example of FIG. 1. In particular, FIG. 2 shows a schematic cross-section of the melting chamber 41 and part of the atomizing vessel 42.

The melting chamber 41 again comprises, inter alia, a crucible 43, a tundish 44 and a filtering device 45. The crucible 43 is arranged for melting a material and is in general configured in substantially the same way as the crucible 5 of FIG. 1. Also the tundish 44 which is arranged for receiving the melted material from the crucible 43, is in general configured in substantially the same way as the tundish 6 of FIG. 1. The example of FIG. 2 differs from the example in FIG. 1 in that the filtering device 45 is connected to the crucible 43.

As schematically shown in FIG. 2, the filtering device 45 is coupled to the crucible 43 of the melting device, wherein the filtering element 45 is arranged at an edge 46 of the crucible 43 which faces the tundish 44. Preferably the filtering element 45 is arranged adjacent to an outflow channel of said crucible 43, which outflow channel is configured for pouring the melted material from the crucible 43 into the tundish 44. In particular the filtering device 45 is connected to the edge 46 of the crucible 43. The crucible 43 is configured for tipping in the direction T1 towards the tundish 44 for pouring melted material over the edge 46 from the crucible 43 into the tundish 44. Since the filtering device 45 is connected to the edge 46 of the crucible 43, the filtering device 45 tilts together with the crucible 43, and when tilted in the direction T1′ towards the tundish 44, the filtering device 45 is arranged in the flow path between the crucible 43 and the tundish 44. The filtering device 45 is arranged for filtering out irregularities from the melted material before it flows into the tundish 44.

Just as the first example in FIG. 1, the crucible 43 of this second example is also configured for tipping in the direction T2 of the disposal system 47 in order to empty the crucible 43 by pouring the melted material from the crucible 43 into the disposal system 47. All other aspects and parts of the assembly 40 for producing powder of this second example may be equal or corresponding to the aspects and parts of the assembly 1 for producing powder according to the first example.

It is noted that the crucible 43 is provided with heating elements 48 for heating and melting the to be melted material inside the crucible 43, and that the tundish 44 is provided with heating elements 49 for at least substantially preventing that the melted material inside the tundish 44 cools off.

As schematically shown in FIG. 2, the melting chamber 41 also comprises a plug member P with a tip which is configured to be inserted into the opening in the bottom of the tundish 44. Preferably the tip of the plug member P extends into the atomizing nozzle 44′. The plug member P is moveable in a direction towards and away from the tundish 44, in this example substantially in a vertical direction d1. The plug member P allows to substantially closing off the opening in the bottom of the tundish 44, in order to control the starting or stopping of the atomizing process. In addition, the tip of the plug member P can be used for pushing any residual material out of the opening in the bottom of the tundish 44 and preferably out of the atomizing nozzle 44′ when substantially all material has been flowing out of the tundish 44.

It is noted that the atomizing nozzle 44′ and the outlet opening of the tundish 44 are connected to provide a flow passage for the melted material. The atomizing nozzle 44′ or the construction around the atomizing nozzle 44′ comprises a supporting and/or sealing member for the tundish 44, in particular for arranging the outlet opening of said tundish 44 adjacent or adjoining an inlet opening of said atomizing nozzle 44′. The atomizing nozzle 44′ and the tundish 44 in this embodiment are separate components. Preferably, the atomizing nozzle 44′ is configured so that the tundish 44 abuts the atomizing nozzle 44′ and its position with respect to the atomizing nozzle is maintained at least substantially by gravity. Accordingly the tundish 44 can easily be separated from the atomizing nozzle 44′ by lifting the tundish 44 from its support, which makes it easy to exchange the atomizing nozzle 44′ and/or the tundish 44 for a new one.

As schematically shown in FIG. 2, the atomizing nozzle 44′ debouches in an upper side of the atomizing vessel 42, just as in the first example of FIG. 1. Accordingly, the further components of the assembly 40 for producing powder may be the same as in the first example as shown in FIG. 1.

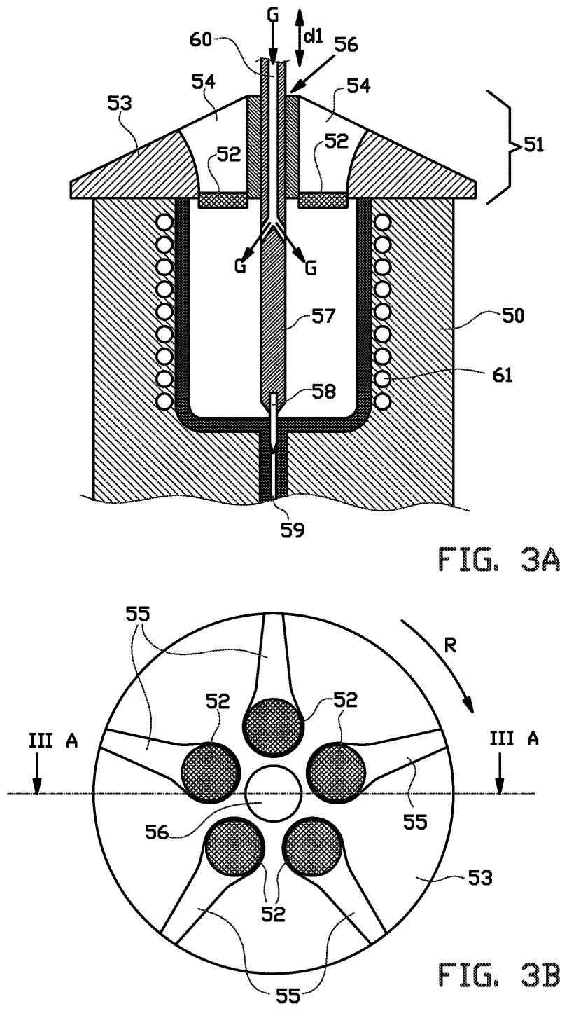

In a third example, an embodiment of the assembly for producing powder comprises a filtering device 51 which is coupled to the tundish 50. As shown in the schematic cross-section of FIG. 3A, the filtering device 51 is arranged in front of an input opening of said tundish 50, in particular, the filtering device 51 is arranged on top of said tundish 50. The filtering device 51 comprises a filter turret 53 as schematically shown in the top view of FIG. 3B, which filter turret 53 comprising multiple filtering elements 52. The filter turret 53 is rotatable in a direction R and/or in a direction opposite to the direction R for moving the filtering elements 52 into and out of the flow path of the liquid material from a crucible into the tundish 50. It is noted that FIG. 3A represents a schematic view of the cross-section along the line IIIA-IIIA in the top view of FIG. 3B.

At each position of a filter element 52, the filter turret 53 comprises a receiving opening 54 for melted material. In use, one of the filter elements 52 is arranged facing a crucible and the melted material is poured out of the crucible into the receiving opening 54 of said one of the filter elements 52. The melted material that traverses said one of the filter elements 52 is then collected in the tundish 50. Accordingly, the one of the filter elements 52 is arranged in between the crucible and the tundish 50, in particular the one of the filtering elements 52 is arranged in the flow path of the liquid material from the crucible and into the tundish 50.

It is noted that the crucible may be arranged with respect to the tundish 50 in the same configuration as shown for example in FIGS. 1 and 2.

As schematically shown in FIG. 3B, the filtering device 51 comprises an overflow arrangement 55 for each of the filter elements 52. Each one of the overflow arrangements 55 is configured for directing at least a part of the liquid material which does not flow through the filtering element 52, to flow in a substantially radial direction away from the filtering element 52. Preferably, a waste container is arranged adjacent the tundish 50 in order to collect the melted material which flows along the overflow arrangement 55 and over the circumferential edge of the turret 53. Such a waste container may be arranged with respect to the tundish 50 in the same configuration as shown for example in FIG. 1.

Furthermore, as schematically indicated in FIGS. 3A and 3B, the turret 53 comprises a central opening 56. The central opening is configured to provide passage for a plug member 57 with a thin tip 58. The tip 58 is configured to be inserted into the opening 59 of the tundish 50. The plug member 57 is moveable in a substantially vertical direction d1. The plug member 57 comprises a tip 58 which is configure for substantially closing off the opening 59 in the bottom of the tundish 50, in order to control the starting or stopping of the atomizing process.

As schematically shown in FIG. 3A, the assembly according to this third example comprises a specially designed plug member 57, which is provided with an internal fluid conduit 60. The fluid conduit 60 debouches in a circumferential surface of the plug member 56, in particular near an upper side of the tundish 50, at least when the tip 58 is arranged inside the opening 59 in the bottom of the tundish 50. The internal fluid conduit 60 is preferably connected to a source for a substantially inert gas G. The internal fluid conduit 60 is configured to provide the inert gas G into the tundish 50, preferably in order to fill the inside of the tundish 50 with said inert gas G. Accordingly, the internal fluid conduit 60 allows to cover the melted material inside the tundish 50 with a layer of inert gas G. Preferably the inert gas G is selected or configured in order to at least substantially prevent contamination of the melted material inside the tundish 50 and/or to at least substantially prevent chemical reactions of the melted material with ambient gasses such as oxidation of the melted material by oxygen. It is noted that such a specially designed plug member with internal fluid conduit can also be applied in any one of the other examples shown in the figures and described herein.

It is noted that the tundish 50 is provided with heating elements 61 for heating the melted material inside the tundish 50 and/or for preventing that the melted material cools off too much before it flows through the opening 59.

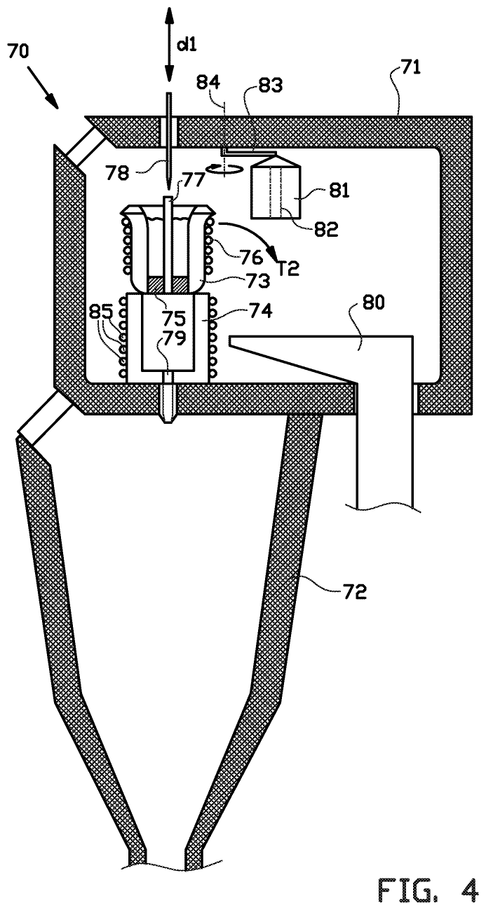

FIG. 4 shows a part of a fourth example of an embodiment of the assembly 70 for producing powder. It is noted that in FIG. 4 only some major components of the assembly 70 are shown to illustrate the difference between this fourth example and the previous examples. In particular, FIG. 4 shows a schematic cross-section of the melting chamber 71 and part of the atomizing vessel 72.

The melting chamber 71 again comprises, inter alia, a crucible 73, a tundish 74 and a filtering device 75.

The crucible 73 is arranged for melting a material and is in general configured in substantially the same way as the crucible 5 of FIG. 1, at least with the exception of the filtering device 75 constitutes at least part of the bottom of the crucible 73. As shown in FIG. 4, the crucible 73 is provided with heating elements 76 for heating and melting material inside the crucible 73. In addition the crucible 73 is provided with a hollow tube 77, which allows to move a plug member 78 though this hollow tube 77 into the tundish 74 in order to use the plug member 78 to close opening 79 in the bottom of the tundish 74.

The tundish 74 is arranged directly underneath the crucible 73. In particular, the upper side of the tundish 74 is arranged directly underneath the filtering device 75 for receiving the melted material from the crucible 73 which has passed the filtering device 75. The tundish 74 is in general configured in substantially the same way as the tundish of the previous examples shown in FIGS. 1, 2 and 3A. It is noted that the tundish 74 is provided with heating elements 85 for heating the melted material inside the tundish 74 and/or for preventing that the melted material cools off too much before it flows through the opening 79.

The example of FIG. 4 differs from the previous examples in that the filtering device 75 is arranged in or at the bottom of the crucible 73 and in that said bottom of the crucible 73 is arranged vertically above the tundish 74. This configuration has the advantage that when the material inside the crucible 73 melts, the melted material will directly flow though the filtering device 75 into the tundish 74 assisted by gravity, in particular without human intervention.

Just as the first example in FIG. 1, the crucible 73 of this fourth example is also configured for tipping in the direction T2 of the disposal system 80 in order to empty the crucible 73 by pouring melted material and/or any residue which does not pass the filtering device 75 out of the crucible 73 into the disposal system 80. It is noted, that at least in the tilted position, the filtering device 75 in the bottom of the crucible 73 is accessible for exchanging the filtering device 75 with a new one, in particular when the filtering device 75 is at least partially clogged up.

It is further noted that the storage container 81 for use in the assembly according to this fourth example, is provided with a central tubular opening 82 for accommodating the hollow tube 77 of the crucible 73. As schematically indicated in FIG. 4, the melting chamber 71 is provided with a manipulator arm 83 which is configured to rotate around a rotation axis 84 for positioning a materials container 81 above the crucible 73. Subsequently the manipulator arm 83 is configured for lowing the materials container 81 into the crucible 73 such that the materials container 81 surrounds the hollow tube 77.

All other aspects and parts of the assembly 70 for producing powder of this fourth example may be equal or corresponding to the aspects and parts of the assembly 1 for producing powder according to the first example.

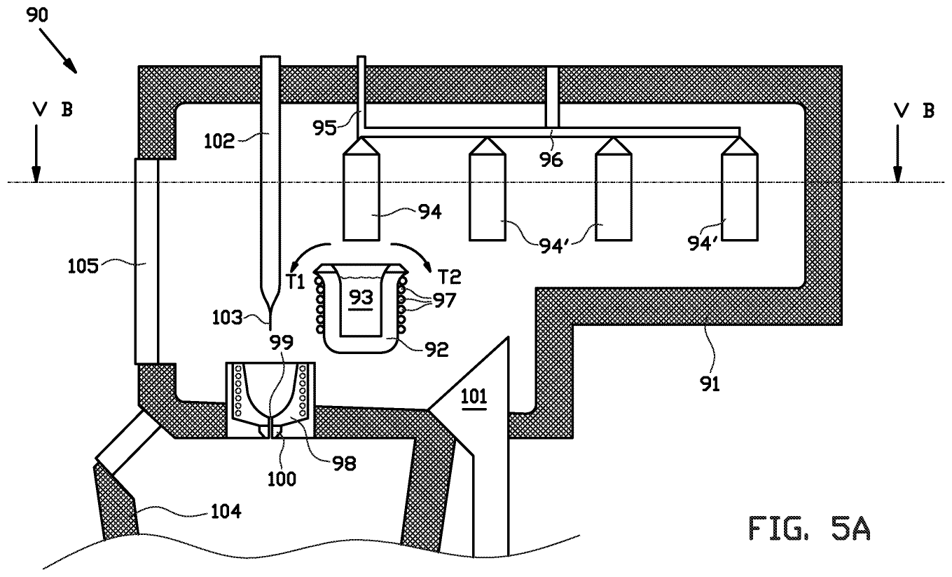

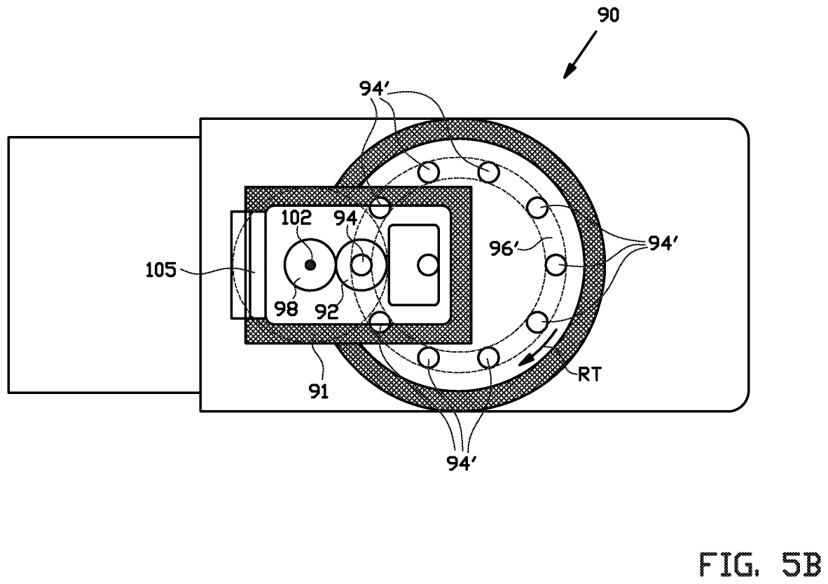

FIG. 5A shows a schematic cross-section of a part of a fifth example of an embodiment of an assembly 90 for producing powder. FIG. 5B shows a top view cross-section along the line B-B of FIG. 5A. In particular, FIG. 5A shows a melting chamber 91 comprising a melting device 92. The melting device 92 comprises an receptacle 93, wherein the receptacle 93 is configured for positioning a materials container 94 into the melting device. The melting device 92 preferably comprises a crucible as is described in the examples above. The materials container 94 comprises to be melted material and the materials container 94 is made from the same, to be melted material, or made from a combustible material.

As schematically shown in FIGS. 5A and 5B, in the melting chamber 91 comprises a transfer device 95. The transfer device 95 is configured for positioning a materials container 94 inside the receptacle 93 of the melting device 92. In addition, the melting chamber 91 comprises a storage device 96 which is arranged for accommodating multiple materials containers 94′ inside the melting chamber 91. The storage device 96 comprises a storage turret 96′ with multiple materials container storage positions, which container storage positions are distributed at the circumference of said storage turret 96′. Accordingly, the turret 96′ is rotatable in a direction RT and/or in a direction opposite to the direction RT for subsequently presenting one of said multiple materials containers 94′ to the transfer device 95.

The transfer device 95 is configured for taking one of said containers 94, 94′ out of the storage device 96, and for positioning the container 94 in the receptacle 93 of the melting device 92.

In the example shown in FIGS. 5A and 5B, the melting device 92 is a crucible which is provided with heating elements 97 for heating and melting the container 94 with its content inside the receptacle 93. The melting chamber 91 further comprises a tundish 98 with an opening 99 in the bottom which connects to an atomizing nozzle 100. In this particular example, the atomizing nozzle 100 and the tundish 98 are be configured as a single combined component.

The crucible 92 is configured for tilting in a direction T1 towards the tundish 98 to provide a flow path for pouring melted material from the crucible 92 into the tundish 98. In addition, the crucible 92 is configured for tilting in a direction T2 towards a disposal system 101. Also a plug member 102 is provided, which plug member 102 is vertically movable for arranging a tip end 103 in the opening 99 of the tundish 98.

The assembly 90 according to this fifth example also comprises an atomizing vessel 104 and a powder processing device comprising one or more separation units, which may be equal or corresponding to the aspects and parts of the assembly 1 for producing powder according to the first example.

In particular, the melting chamber 91 may comprises a filtering device which is arranged between the crucible 92 and the tundish 98, wherein the filtering device is arranged in the flow path for pouring melted material from the crucible 92 into the tundish 98, according to any one of the previous examples.

It is noted that in the fifth example, the melting device 92 is a crucible, and the melted material inside the crucible can be visually examined, for example by an operator OP, via the window 105 in a wall of the melting chamber 91, before it is poured into the tundish 98. However, in an alternative exemplary embodiment, transfer device 95 may be configured to position the materials container 94 directly into the tundish 98. This latter example, the tundish 98 constitutes the melting device for heating and melting the material container with its material content.

The use of the materials containers 18, 81, 94, 94′ provides a major step forward in the production of powder material. The materials containers 18, 81, 94, 94′ provide a constant external shape to the material to be melted, which allows the same and easy handling for each materials container. The materials containers can be filled with to be melted material of substantially any shape, as long as it fits inside the materials container. Accordingly, it is not necessary to break or split the to be melted material into small fractions or bulk material.

In addition, due to the constant external shape, which is preferably accommodated to the internal shape of the crucible, the materials containers can be positioned in a hot crucible. This allows to use the assembly for powder production according to the present invention in repeating atomization runs in which repeatedly the following steps are performed:
a. a new materials container is arranged in the hot crucible,
b. after the materials container and the to be melted material therein has been melted, pouring the liquid material into the tundish, preferably via a filtering device,
c. after the liquid material has been poured into the tundish, the hot crucible is filled with a new materials container (go back to step a).

For example, the to be melted material is placed in several materials containers 94, 94′. Each materials container has a volume of 1 liter and could hold about 4 to 5 kg metal material. If we have 10 materials containers 94, 94′ in a setup as for example shown in FIGS. 5A and 5B, 40 to 50 kg metal material is available for atomization into powder. In use, the materials containers 94, 94′ are place inside the crucible one after the other. The next materials container can be place in the still hot crucible immediately after the liquid metal from the previous materials container has been poured out of the hot crucible. This allows to establish a semi-continues process for powder production in which the crucible and the tundish need not be cooled down in between new charges of to be melted material, which reduces the thermal stress on these fragile components and thereby increases the lifespan of these components.

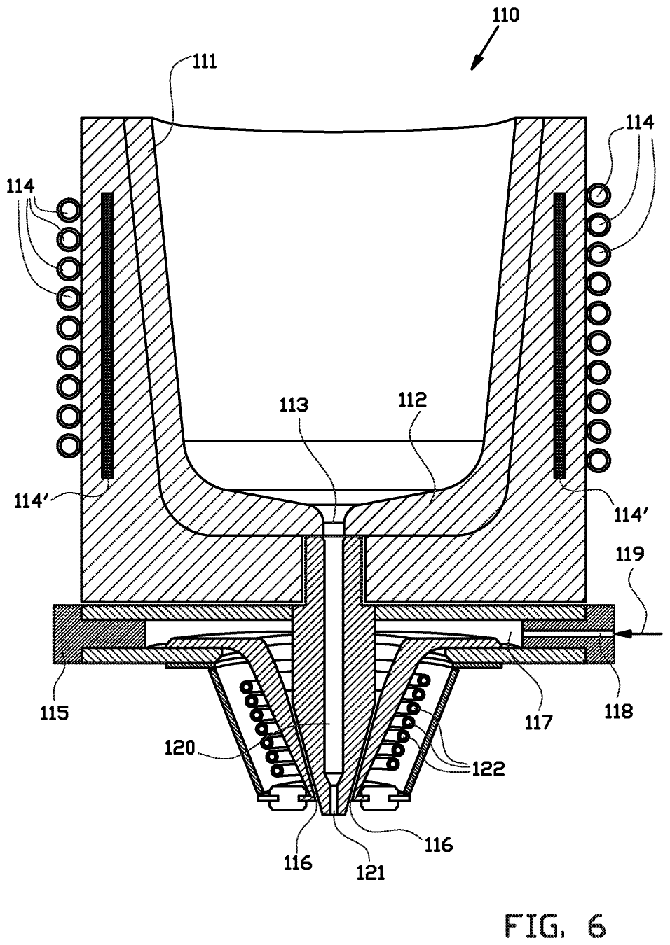

FIG. 6 shows a schematic cross-section of an example of an embodiment of a tundish 110 for use in an assembly for producing powder, in particular for use in an assembly for producing powder as described in the various examples above. The tundish 110 comprises an receptacle 111 for melted material. The receptacle comprises a bottom wall 112 with an outlet opening 113 for melted material. The receptacle is provided with a heating device 114 for heating material inside the receptacle 111. Preferably, the heating device 114 comprises an inductive heating device for inductively heating metal, preferably melted metal, in the receptacle 111. In the example shown in FIG. 6, the heating device 114 comprises a coil which spirals around the receptacle 111, and which in use is connected to a power source for directing a suitable current through the coil for inductively heating metal inside the receptacle 111. As shown in the example of FIG. 6, the coil comprises a hollow tube which allows to provide a cooling fluid to flow through the tube for cooling the heating device 114 during use.

It is noted that an inductive heating device 114 provides heat directly to electrically conductive material, such as metal, inside the receptacle 111. Since the receptacle 111 is preferably made from a ceramic material, which preferably is not electrically conductive, the inductive heating device 114 cannot heat up the receptacle 111 when no electrically conductive material is inside. In order to heat up the receptacle 111 before liquid metal is poured into the receptacle 111, preferably via a filtering device, as described above, the receptacle is preferably provided with a secondary heating device 114′, which is preferably arranged in the side walls and/or in isolation material surrounding the side walls as schematically shown in FIG. 6.

In an embodiment, the secondary heating device 114′ comprises an electrically conductive material, which is heated by means of the inductive heating device 114. In addition or alternatively, in an embodiment, the secondary heating device 114′ comprises a resistive heating.

As shown in FIG. 6, the tundish 110 is arranged on top of an atomizing nozzle 115. Although the atomizing nozzle 115 and the tundish 110 can be configured as a single combined component, it is preferred that the atomizing nozzle 15 and the tundish 110 are separate components.

The atomizing nozzle 115 comprises a flow channel 120 which is in fluid communication with the outlet opening 113 of the receptacle 111 in order to allow melted material to flow from the receptacle 111 through the atomizing nozzle 115 to an atomizing outlet 121. The atomizing nozzle 115 is further provided with gas outlets 116 for directing gas jets onto the flow of melted material out of the atomizing outlet 121. The gas outlets 116 are arranged adjacent and at least partially surrounding the atomizing outlet 121 of the atomizing nozzle 115.

In the example showed in figured 6, the gas outlets 116 are in fluid connection with a gas reservoir 117. In use, the gas reservoir 117 is connected to a supply 119 for pressurized gas via a supply channel 118.

Furthermore, the atomizing nozzle 115 of this example is provided with an nozzle heating device 122. The nozzle heating device 122 comprises an inductive and/or resistive heating device for heating at least the flow channel 120 and/or the material inside the flow channel 120, preferably melted metal in at least the lower part of the flow channel 120. The nozzle heating device 121 comprises a coil which spirals around the flow channel 120, and which in use is connected to a power source for directing a suitable current through the coil for inductively and/or resistively heating the flow channel 120. In case the nozzle heating device 122 is configured as an inductive heating, the coil preferably comprises a hollow tube which allows to provide a cooling fluid to flow through the tube for cooling the nozzle heating device 122 during use.

Due to the nozzle heating device 122, it can substantially be prevented that the melted material in the flow channel 120 clogs up the flow channel 120 and/or the atomizing outlet 121. Without such a nozzle heating device 122, the temperature of the melted material in the flow channel 120 when traveling from the receptacle 111 to the atomizing outlet 121 may decreases. When the temperature of the melted material in the flow channel decreases, the viscosity of the melted material will increase, the flow of the melted material through the flow channel 120 will decrease further, and the temperature of the melted material will decrease even further, up to the moment that the material in the flow channel 120 is no longer flowing and the flow channel and the atomizing nozzle are blocked, which is also known as nozzle freeze.

During the atomization of a material, the liquid material flows out of the atomizing outlet 121. Various beams of pressurized gas from the gas outlets 116 blow against the liquid material below the atomizing nozzle 115, and the liquid material is atomized or nebulized to form small droplets of liquid material. The small droplets are substantially airborne, cool down and solidify to form powder.

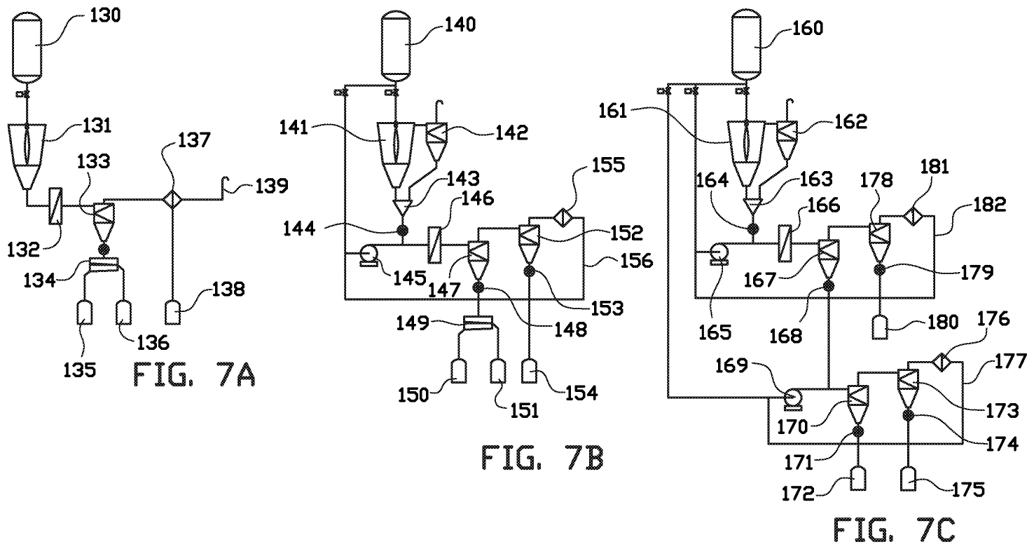

The assembly of the present invention utilizes the fact that the liquid droplets and the resulting powder are/is airborne in the pressurized gas for transporting the powder further through the assembly for processing the powder and/or separating the powder from the gas flow. Various examples of powder processing arrangements are shown in FIGS. 7A, 7B and 7C.

FIG. 7A shows a first example of an assembly for processing and/or separating the powder. The assembly comprises a source 130 for pressurized gas which in use supplies pressurized gas to the atomizing nozzle, which pressurized gas impinges on to or into the stream of molten material to form a liquid droplets from the formerly molten material in the atomizing vessel 131. The liquid droplets are suspended in the gas, cool down and solidify. Since the solidified droplets which form the powder are suspended in the gas, the gas is used to transport the powder through the assembly.

As soon as the temperature of the droplets is below the melting temperature of the material, the gas with suspended solidified droplets which form the powder are guided through a heat exchange unit 132 for cooling down the powder to make it easier to process the powder downstream. In addition, active cooling the powder by the heat exchange unit 132 substantially prevents that the parts of the assembly downstream of the heat exchange unit 132 heat up to much.

Downstream the heat exchange unit 132, the airborne powder is introduced into a cyclone or air classifier 133 serving to separate powder particles from the gas, wherein the separated powder gravitates towards the downward outlet of the cyclone or air classifier 133 towards a sifting unit 134. Lightweight and small powder particles do not gravitate towards the downward outlet, but are carried away by the gas via the upper outlet towards a filtering unit 137.

In the sifting unit 134, course powder particles, which have a size bigger than the mesh size of the sieve in the sifting unit 134, are directed to a course powder particle container 136. The medium size powder particles, which have a size smaller than the mesh size of the sieve in the sifting unit 134, are directed to a medium powder particle container 135.

In the filtering unit 137, the lightweight and small particles are removed from the gas flow and are directed to a fine powder particle container 138. The filtered gas is subsequently expelled via a gas exhaust 139.

FIG. 7B shows a second example of an assembly for processing and/or separating the powder. The assembly comprises a source 140 for pressurized gas which in use supplies pressurized gas to the atomizing nozzle, which pressurized gas impinges on to or into the stream of molten material to form a liquid droplets from the formerly molten material in the atomizing vessel 141. The liquid droplets are suspended in the gas, cool down, solidify into powder particles, accumulate at the downward outlet of the atomizing vessel and are directed to an intermediate buffer 143.

The smaller solidified droplets, which are suspended in the turbulent gas, are removed out of the atomizing vessel 141 together with the gas at an upper outlet of the atomizing vessel and are directed to a cyclone or air classified 142. The mixture of gas with airborne solidified droplets is introduced into the cyclone or air classifier 142 serving to separate the solidified droplets from the gas, wherein the solidified droplets gravitate towards the downward outlet of the cyclone or air classifier 142 towards the intermediate buffer 143. The gas is removed out of the cyclone or air classified 142 via an upper outlet and is expelled via a gas exhaust.

In the intermediate buffer 143 the powder particles are preferably sifted in order to remove the most course particles, using a sieve with a mesh size preferably larger than 20 micro-meters, for example using a sieve with a mesh size of 200 micro-meters.

The assembly further comprises an valve 144 at the output of the intermediate buffer 143 in order to control the output of powder material from the intermediate buffer 143 to the separation units, which in this example have a dedicated gas-circuit. This dedicated gas-circuit comprises a pump 145 for generating a gas flow, which is mixed with the powder particles from the intermediate buffer 143. The gas flow transports the powder particles through a heat exchange unit 146 for cooling down the powder, and then towards a first cyclone or air classifier 147 serving to separate powder particles from the gas.

In the first cyclone or air classifier 147, a first fraction of the powder gravitates towards the downward outlet of the cyclone or air classifier 147, and is directed via an outlet valve 148 towards a sifting unit 149.

In the sifting unit 149, course powder particles, which have a size bigger than the mesh size of the sieve in the sifting unit 149, are directed to a course powder particle container 151. The medium size powder particles, which have a size smaller than the mesh size of the sieve in the sifting unit 149, are directed to a medium powder particle container 150.

Lightweight and small powder particles, which do not gravitate towards the downward outlet of the first cyclone or air classifier 147, are carried away by the gas via the upper outlet towards a second cyclone or air classifier 152. In the second cyclone or air classifier 152, a second fraction of the powder gravitates towards the downward outlet of the cyclone or air classifier 152, and is directed via an outlet valve 153 to a fine powder particle container 154.

Very lightweight and small powder particles, which do not gravitate towards the downward outlet of the second cyclone or air classifier 152, are carried away by the gas via the upper outlet towards filtering unit 155. In the filtering unit 155 substantially all remaining particles are removed from the gas flow, and the gas is directed to the inlet of the pump 145 and/or mixed with the gas from the source 140 for pressurized gas which in use supplies pressurized gas to the atomizing nozzle. Accordingly, at least a part of the gas in the dedicated gas-circuit of the separation units can be re-used.

FIG. 7C shows a third example of an assembly for processing and/or separating the powder. The assembly comprises a source 160 for pressurized gas which in use supplies pressurized gas to the atomizing nozzle, which pressurized gas impinges on to or into the stream of molten material to form a liquid droplets from the formerly molten material in the atomizing vessel 161. The liquid droplets are suspended in the gas, cool down, solidify into powder particles, accumulate at the downward outlet of the atomizing vessel and are directed to an intermediate buffer 163.

The smaller solidified droplets, which are suspended in the turbulent gas, are removed out of the atomizing vessel 161 together with the gas at an upper outlet of the atomizing vessel and are directed to a cyclone or air classified 162. The mixture of gas with airborne solidified droplets is introduced into the cyclone or air classifier 162 serving to separate the solidified droplets from the gas, wherein the solidified droplets gravitate towards the downward outlet of the cyclone or air classifier 162 towards the intermediate buffer 163. The gas is removed out of the cyclone or air classified 162 via an upper outlet and is expelled via a gas exhaust.

In the intermediate buffer 163 the powder particles are preferably sifted in order to remove the most course particles, using a sieve with a mesh size preferably larger than 20 micro-meters, for example using a sieve with a mesh size of 200 micro-meters.

The assembly further comprises an valve 164 at the output of the intermediate buffer 163 in order to control the output of powder material from the intermediate buffer 163 to the separation units, which in this example have a dedicated first gas-circuit. This dedicated first gas-circuit comprises a first pump 165 for generating a gas flow which is mixed with the powder particles from the intermediate buffer 163. The gas flow transports the powder particles through a heat exchange unit 166 for cooling down the powder, and then towards a first cyclone or air classifier 167 serving to separate powder particles from the gas.

In the first cyclone or air classifier 167, a first fraction of the powder gravitates towards the downward outlet of the cyclone or air classifier 167, and is directed via an outlet valve 168 towards a second gas-circuit.

Lightweight and small powder particles, which do not gravitate towards the downward outlet of the first cyclone or air classifier 167, are carried away by the gas via the upper outlet towards a second cyclone or air classifier 178. In the second cyclone or air classifier 178, a second fraction of the powder gravitates towards the downward outlet of the cyclone or air classifier 178, and is directed via an outlet valve 179 to a fine powder particle container 180.

Very lightweight and small powder particles, which do not gravitate towards the downward outlet of the second cyclone or air classifier 178, are carried away by the gas via the upper outlet towards filtering unit 181. In the filtering unit 181 substantially all remaining particles are removed from the gas flow, and the gas is directed back to the inlet of the pump 165 and/or mixed with the gas from the source 160 for pressurized gas which in use supplies pressurized gas to the atomizing nozzle.

The first fraction of powder particles from the first cyclone or air classifier 167 is directed to a second gas-circuit which comprises a second pump 169 for generating a gas flow which is mixed with the first fraction of powder particles from first cyclone or air classifier 167. The gas flow transports the powder particles towards a third cyclone or air classifier 170 serving to separate powder particles from the gas.

In the third cyclone or air classifier 170, a third fraction of the powder gravitates towards the downward outlet of the cyclone or air classifier 170, and is directed via an outlet valve 171 towards a course powder particle container 172.

Lightweight and small powder particles, which do not gravitate towards the downward outlet of the third cyclone or air classifier 170, are carried away by the gas via the upper outlet towards a fourth cyclone or air classifier 173. In the fourth cyclone or air classifier 173, a second fraction of the powder gravitates towards the downward outlet of the cyclone or air classifier 173, and is directed via an outlet valve 174 to an intermediate powder particle container 175.

Very lightweight and small powder particles, which do not gravitate towards the downward outlet of the fourth cyclone or air classifier 173, are carried away by the gas via the upper outlet towards filtering unit 176. In the filtering unit 176 substantially all remaining particles are removed from the gas flow, and the gas is directed back to the inlet of the second pump 169 and/or mixed with the gas from the source 160 for pressurized gas which in use supplies pressurized gas to the atomizing nozzle.

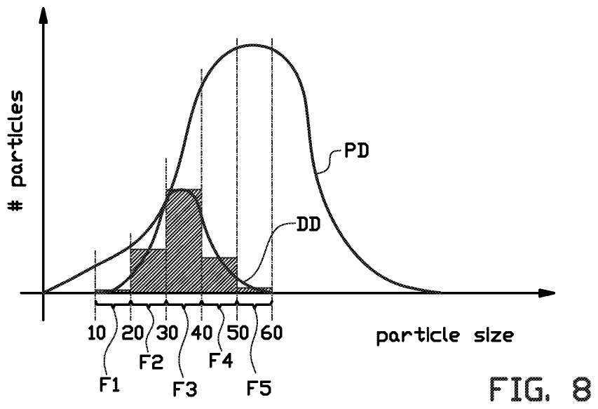

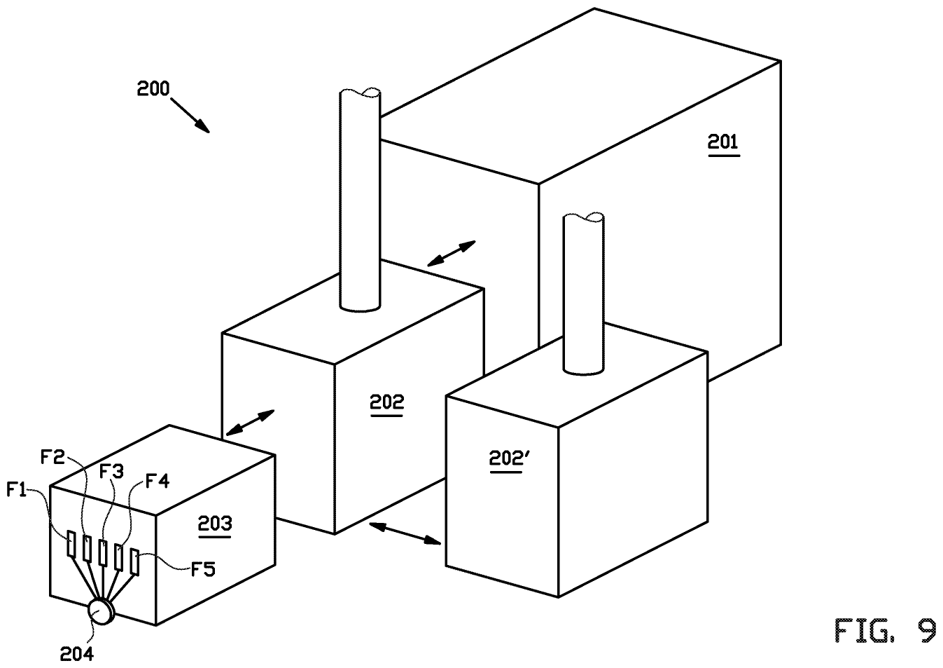

It is noted that the process of producing powder using an assembly according to the present invention, delivers powders with a certain particle size distribution PD, as schematically shown in FIG. 8. This particle size distribution PD may not a suitable distribution for use, for example, in a three-dimensional printing apparatus. The previous examples in FIGS. 7A, 7B and 7C show different assemblies for processing and/or separating the powder in different fractions F1, F2, F3, F4, F5. Accordingly, in an embodiment, the assembly for producing powder according to the invention allows to separate the produced powder with powder particles with the certain weight distribution PD and/or size distribution in several different fractions F1, F2, F3, F4, F5. By combining different amounts of powder from one or more of these several different fractions F1, F2, F3, F4, F5, a powder with weight and/or size distribution equal or close to a desired distribution DD can be obtained. It is noted that in case one or more of the collected fractions F1, F2, F3, F4, F5 of powder material is not desired or not needed for short term use, and the powder material with sizes outside these fractions, may be recycled by putting this powder material inside a materials container for future use in the assembly of the invention for the production of powder material.

In a further exemplary embodiment as schematically shown in FIG. 9, the assembly 200 comprises a combining unit 203, which is configured to combine amount of powder from several fractions F1, F2, F3, F4, F5 in order to provide a powder mixture at the output 204 with a preselected weight and/or size distribution of particles in said powder mixture.

In addition FIG. 9 schematically shows a modular setup for an assembly 200 for producing powder. This modular setup comprises a first module 201, which comprises a melting chamber and an atomizing vessel, for example as described in any of the previous examples. In addition, the modular setup comprises a second module 202, which comprises the powder processing device, and a third module 203, which comprises the combining unit.

From the various examples of powder processing arrangements, as for example shown in FIGS. 7A, 7B, 7C, these powder processing arrangement comprises a large number of individual powder handling components, such a sifting devices, cyclones, air classifiers, etc. . . . Accordingly, the powder processing arrangements are difficult to clean and to remove all residual material from a previous run out of the powder processing arrangement for utilizing the powder processing arrangement for producing powder of a different material in a next run. When some residues from a first material remains in the powder processing device, and the same powder processing device is used for processing a second material different from said first material, the second material can be contaminated by the residues of the first material. In order to circumvent such contamination, the assembly 200 is provided with two or more powder processing devices 202, 202′ for processing atomized particles of different materials. Different materials can be processed separately in dedicated powder processing devices 202, 202′ and only the melting chamber and the atomizing vessel in the first module 201 needs to be cleaned when changing from a first material to a second material. Accordingly, FIG. 9 shows an assembly 200 with interchangeable powder processing devices 202, 202′.

It is noted that in case the combining unit 203 is used for the different materials, also the combining unit 203 must be cleaned when changing from the first material to the second material. Alternatively, each powder processing device 202, 202′ may comprise its own combining unit 203. In particular, the combining unit 203 may be integrated or form an integral part of the powder processing device 202, 202′.

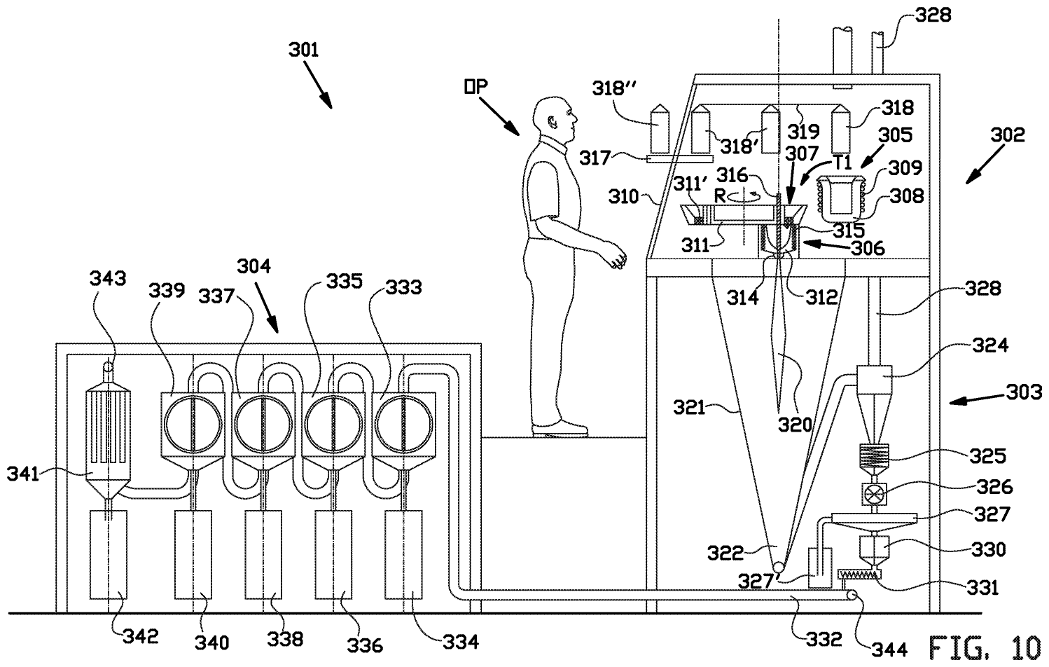

FIG. 10 schematically shows an example of an assembly 301 according to the present invention. The assembly comprises a melting chamber 302, an atomizing vessel 303, and a powder processing device 304.

The melting chamber 302 comprises, inter alia, a crucible 305, a tundish 306 and a filtering device 307. The crucible 305 is arranged for melting metal material for producing metal powder. The crucible 305 comprises a container 308 which is made from a ceramic material and is provided with a coil 309 for inductively heating and melting metal material inside said crucible 305. At least in use the coil 309 is connected to a power source for directing a suitable current through the coil 309 for inductively heating the metal inside the container 308. The crucible 305 and tundish 306 are configured for providing a flow path for said melted material from the crucible 305 into the tundish 306. In particular, the crucible 305 is configured for tipping in the direction T1 of the tundish 306 and for pouring melted material from the crucible 305 into the tundish 306.

As schematically indicated in FIG. 10, the filtering device 307 is arranged in said flow path between the crucible 305 and the tundish 306. The filtering device 307 comprises a filter turret 311, which filter turret 311 comprising multiple filtering elements 311′. The filter turret 311 is rotatable in a direction R and/or in a direction opposite to the direction R for moving the filtering elements 311′ into and out of the flow path of the liquid material from a crucible 305 into the tundish 306.

The tundish 306 comprises a container 312 with an opening in the bottom wall, which opening connects to an atomizing nozzle 314. The tundish 306 also comprises a resistively heating device 215 for heating the tundish 306 and a material inside the container 312.

As schematically shown in FIG. 10, the melting chamber 302 also comprises a plug member 316 with a tip, which tip is configured to be inserted into the opening of the tundish 306 and also into the atomizing nozzle 314. The plug member 316 is moveable in a direction towards and away from the tundish 306, in an analog way as described above and shown in FIGS. 1, 2, 3A, 4 and 5A. The plug member is preferably also provided with an internal fluid conduit as shown in FIG. 3A. The fluid conduit debouches in a circumferential surface of the plug member 316, and is connected to a source for a substantially inert gas. Accordingly, inert gas can be introduced into the tundish 306, in order to fill the inside of the tundish 306 with said inert gas.

Furthermore, the melting chamber 302 comprises a materials containers 318, 318′ comprising to be melted material. The materials containers 318, 318′ are connected to a manipulator device 319 which allows positioning the materials container 318 into the crucible 305, and release the materials container 318. In addition, the manipulator 319 is configured for accommodating multiple materials containers 318′ inside the melting chamber 302, and for subsequently positioning one of said multiple materials containers 318′ into the crucible 305. After the crucible 305 has melted at least the material inside the materials container 318, and the melted material is poured out of the crucible 305 into the tundish 306, the manipulator 319 then can position a further materials container 318′ into the crucible 305. Accordingly, the melting and atomizing process can continue as long as there are materials containers 318, 318′ to be successively placed in the crucible 305. The melting chamber 302 is furthermore provided with a supply arrangement 317 for supplying further materials contains 318″ into the melting chamber 302.

The melting chamber 302 is preferably provided with observation means which allow the operator OP to view and check the process in the melting chamber 302. This observation means comprises a window 310 in a side wall of the melting chamber 302.

As schematically shown in FIG. 10, the atomizing nozzle 314 which is in fluid connection with the tundish 306, debouches in an upper side of the atomizing vessel 321. The atomizing nozzle 314 is configured to direct molten material towards and into the atomizing vessel 321, and to direct one or more jets of a fluid, preferably a gas, towards the flow of molten material in order to split the flow of molten material into small droplets. The cloud of droplets 320 is pushed away from the atomizing nozzle 314 and the droplets in the cloud of droplets 320 cool down and solidify as they travel through the atomizing vessel 321.

The atomizing vessel 321 further comprises an outlet 322 which is configured to extract solidified, atomized particles of the formerly molten material from the atomizing vessel 321. The fluid used in the atomizing process also leaves the atomizing vessel 321 via the outlet 322 and takes the solidified, atomized particles along with it towards a cyclone or air classifier 324, which separates the solidified, atomized particles from the fluid. The solidified, atomized particles gravitate towards the downward outlet of the cyclone or air classifier 324 towards a cooling member 325, and via a valve 326 and a course sieve 327, into an intermediate buffer 330. The gas is removed out of the cyclone or air classified 324 via an upper outlet and is expelled via a gas exhaust 328. The cooling member 325 is preferably a heat exchanger which is configured for cooling down the solidified, atomized particles. In the course sieve 327 the powder particles are preferably sifted in order to remove the most course particles, using a sieve with a mesh size of 200 micro-meters. The most course particles are collected and provided to a first residue container 327′.

The resulting powder in the intermediate buffer 330 is transported by a screw conveyor 331 and delivered to a gas supply line 332 towards the powder processing device 304. The gas with solidified, atomized particles is directed from the supply line 332 to a series arrangement of several filter devices 333, 335, 337, 339, preferably gas-driven sieving devices, each filtering out a predetermined size fraction from the powder, and delivering each size fraction in a corresponding container 334, 336, 338, 340.

Very lightweight and small powder particles, which pass all the filtering devices 333, 335, 337, 339, are carried away by the gas towards final filtering unit 341, for example comprising HEPA filters. In the final filtering unit 341 substantially all remaining particles are removed from the gas flow, and the gas is directed via an outlet 343 to a pump (not shown), which pump is configured for pressurizing gas and supplying the pressurized gas to the inlet 344 of the supply line 332. The remaining particles can at least partially be collected in a second residue container 342. It is noted that the gas used in the powder processing device 304 can be air, but preferably the gas is a substantially inert gas. Preferably the inert gas is selected or configured in order to at least substantially prevent contamination of the powder material and/or to at least substantially prevent chemical reactions of the powder material such as oxidation.

It is noted that the material from the first and/or second residue containers 327′, 342 can be collected and recycled by putting these inside a materials container 318″ for future use in the assembly 301 for the production of powder material.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

In summary, the present invention relates to an assembly and method for producing powder. The assembly comprises:
a melting chamber comprising a crucible, a tundish and a filtering device, wherein the crucible is arranged for melting a material, wherein the crucible and tundish are configured for providing a flow path for said melted material from the crucible into the tundish, wherein the filtering device is arranged in said flow path, wherein the tundish is connected to an atomizing nozzle,
an atomizing vessel, wherein the atomizing nozzle is configured to direct molten material from the tundish towards and into the atomizing vessel, wherein the atomizing vessel comprises an outlet which is configured to extract solidified, atomized particles of the formerly molten material from the atomizing vessel, and
a powder processing device comprising one or more separation units which are arranged for outputting one or more powders from said atomized particles.

1. An assembly for producing powder, wherein said assembly comprises:
a melting chamber comprising a transfer device, a melting device and a tundish,
wherein the melting device comprises a crucible for melting metal material and holding said melted metal material,
wherein the transfer device is configured to position metal material into the crucible at elevated temperature,
wherein the crucible is configured for providing a flow path for allowing a flow of said melted metal material from the crucible into the tundish,
wherein the tundish is connected to an atomizing nozzle,
wherein the melting chamber further comprises a filtering device with a filtering element which is arranged between the crucible and the tundish,
wherein the filtering element is arranged in said flow path,
an atomizing vessel comprising an inlet end,
wherein the atomizing nozzle is configured to direct molten metal material from the tundish towards and into the inlet end of the atomizing vessel,
wherein the atomizing vessel comprises an outlet opening which is configured to extract solidified, atomized particles of the formerly molten metal material from the atomizing vessel, and
a powder processing device connected to the outlet opening of the atomizing vessel,
wherein said powder processing device comprising multiple separation units,
wherein each separation unit of said multiple separation units is configured for extracting a different fraction out of the solidified atomized particles from the atomizing vessel,
wherein the different fractions comprise different weight fractions and/or different size fractions, and for providing multiple different fractions as separate products of the assembly for producing powder.

2. The assembly according to claim 1, wherein the crucible is configured for holding melted metal material with a volume in a range of approximately 10—0.1 liters.

3. The assembly according to claim 1, wherein the transfer device is configured to position a materials container into the crucible, wherein the crucible is heated at or near a melting temperature of the metal material.

4. The assembly according to claim 3, wherein the materials container comprises to be melted material,
wherein the materials container is made from the same, to be melted material, or
wherein the materials container is made from a combustible material.

5. The assembly according to claim 3, wherein the melting chamber comprises a storage device which is arranged for accommodating multiple materials containers inside the melting chamber,
wherein the storage device is configured for subsequently presenting one materials container of said multiple materials containers to the transfer device, and/or
wherein the transfer device is arranged for taking one materials container of said multiple materials containers out of the storage device.

6. The assembly according to claim 5, wherein the storage device comprises a storage turret with multiple materials container storage positions.

7. The assembly according to claim 1, wherein the assembly comprises a fluid conduit,
wherein the fluid conduit debouches near and/or in the tundish for providing a substantially inert gas into the tundish

8. The assembly according to claim 1, wherein the powder processing device comprises:
one or more sifting units, wherein each sifting unit of said one or more sifting units is arranged for extracting a predetermined size fraction of atomized particles;
one or more cyclone separation units, wherein each cyclone separation unit of said one or more cyclone separation units is arranged for extracting a predetermined weight fraction of atomized particles; or
one or more air classifiers, wherein each air classifier of said one or more air classifiers is arranged for extracting a predetermined fraction of atomized particles based on a combination of size, shape and density.

9. The assembly according to claim 1, wherein the powder processing device comprises a combining unit which is configured to combine amounts of powder from several of different fractions in order to provide a powder mixture with a preselected size and/or weight distribution.

10. The assembly according to claim 1, wherein the assembly comprises two or more powder processing devices, each powder processing device is configured for processing atomized particles of one predetermined metal or metal alloy, and
wherein each of the two or more powder processing device are configured for processing atomized particles of a different metal or metal alloy.

11. The assembly according to claim 1, wherein the filtering element is configured to filter out:
contaminations and/or particles with a diameter substantially equal to or larger than a diameter of the atomizing nozzle; and/or
oxides, wherein said oxides comprises a different viscosity as the melted metal material.

12. The assembly according to claim 1,
wherein the filtering device is coupled to the crucible, wherein the filtering element is arranged adjacent to an outflow channel of said crucible;
wherein the filtering device is coupled to the tundish, wherein the filtering element is arranged in front of an input opening of said tundish; or
wherein the filtering device is arranged spaced apart from the crucible and the tundish,
wherein the filtering element is arranged in the flow path of the liquid material from the crucible and into the tundish.

13. The assembly according to claim 1, wherein the filtering device comprises an overflow arrangement,
wherein the overflow arrangement is configured for directing at least a part of the liquid material which does not flow through the filtering element, to flow into a waste container.

14. The assembly according to claim 1, wherein the filtering device comprises a filter turret comprising multiple filtering elements,
wherein the filter turret is rotatable for moving one of the multiple filtering elements into and out of the flow path of the liquid material.

15. A method for producing powder using an assembly according to claim 1, wherein the method comprises the steps of:
positioning an amount of material in a hot crucible,
melting the amount of material in the crucible,
transferring the liquid material from the crucible to a tundish, wherein the liquid material from the crucible traverses a filtering element before the liquid material flows into the tundish,
directing molten material from the tundish, via an atomizing nozzle towards and into an inlet end of an atomizing vessel in order to produce atomized particles which solidify in the atomizing vessel,
extracting the solidified, atomized particles of the formerly molten material via an outlet opening of the atomizing vessel and directing said solidified atomized particles to a powder processing device,
using multiple separation units of the powder processing device such that each separation unit of said multiple separation units extracts a different fraction out of the solidified atomized particles from the atomizing vessel,
wherein the different fractions comprise different weight fractions and/or different size fractions and providing multiple different fractions as separate products of the assembly for producing powder.

16. The method according to claim 15, wherein the steps of the method are subsequently carried out and/or are carried out recurrently, without substantially cooling down the crucible.

17. A materials container for use in an assembly for producing powder,
wherein the materials container is configured to comprise to be melted material,
wherein the materials container is made from a combustible material, or
wherein the materials container is made from the same, to be melted, material.

18. An assembly for producing powder,
wherein said assembly comprises a melting chamber comprising a melting device,
wherein the melting device comprises a receptacle and a heating device,
wherein the receptacle is configured for receiving a materials container according to claim 17,
wherein the melting device is configured for heating the materials container in the receptacle.

19. The assembly according to claim 18, wherein the melting device comprises a crucible,
wherein the melting chamber further comprises a tundish,
wherein the crucible is configured for providing a flow path for allowing a flow of melted material from the crucible into the tundish,
wherein the tundish comprises an outlet, wherein the assembly further comprises:
an atomizing nozzle in fluid connection with the outlet of said tundish,
an atomizing vessel comprising an inlet end,
wherein the atomizing nozzle is configured to direct molten material towards and into the inlet end of the atomizing vessel,
wherein the atomizing vessel comprises an outlet opening which is configured to extract solidified, atomized particles of the formerly molten material from the atomizing vessel, and
a powder processing device comprising one or more separation units which are arranged for outputting one or more powders from said atomized particles.

20. The assembly according to claim 19, wherein the melting chamber further comprises a filtering device which is arranged between the crucible and the tundish,
wherein the filtering device is arranged in said flow path.
